(19) United States
(12) Patent Application Publication
(10) Pub. No.: US 2002/0013242 A1
(43) Pub. Date: Jan. 31, 2002

(54) Detergent-package combination

(76) Inventors: Gerard Marcel Baillely, Gosforth (GB); Paul Amaat Raymond G. France, Bertem (BE); Carole Patricia D. Wilkinson, Bruxelles (BE)

Correspondence Address: THE PROCTER & GAMBLE COMPANY, PATENT DIVISION, MIAMI VALLEY LABORATORIES, P.O. BOX 538707, CINCINNATI, OH, 45253-8707, US

(21) Appl. No.: 09/933,021

(22) Filed: Aug. 20, 2001

Related U.S. Application Data
(63) Continuation of application No. 08/581,574, filed on Jan. 16, 1996, now abandoned.

(30) Foreign Application Priority Data
Jul. 14, 1993 (EP) 93870141.4
Jun. 23, 1994 (EP) 94304555.9
Jul. 13, 1994 (US) PCT/US94/07831

(51) Int. Cl. C11D 17/00; C11D 7/18; C11D 17/06

(52) U.S. Cl. 510/220; 510/277; 510/293; 510/296; 510/297; 510/309; 510/439

(57) ABSTRACT

The present invention provides the combination of a granular detergent composition containing a percarbonate bleaching agent with packaging system containing said composition, characterized in that said composition has an Equilibrium Relative Humidity below 30% at 35° C., and that the packaging system contains at least one unit having a Moisture Vapour Transfer Rate of from 1 g/m2/day to less than 20 g/m2/day.

### CROSS REFERENCE

This application is a Continuation of patent application Ser. No. 08/581,574 filed Jul. 13, 1994, which claims priority to PCT/US94/07831 filed Jul. 13, 1994.

### TECHNICAL FIELD

The present invention relates to detergent compositions containing percarbonate bleach; it provides a combination between such compositions and a packaging system containing them, such combination yielding optimum bleach stability.

### BACKGROUND OF THE INVENTION

The inorganic perhydrate bleach most widely used in laundry detergent compositions is sodium perborate in the form of either the monohydrate or tetrahydrate. However, an increasing interest in other perhydrate salts is being observed, of which sodium percarbonate is the most readily available.

Detergent compositions containing sodium percarbonate are known in the art. Sodium percarbonate is an attractive perhydrate for use in detergent compositions because it dissolves readily in water, is weight efficient and, after giving up its available oxygen, provides a useful source of carbonate ions for detergency purposes.

The inclusion of percarbonate salts in laundry detergent compositions has been restricted hitherto by the relative instability of the bleach. In particular, percarbonate salts decompose rapidly when stored in a moist and/or warm atmosphere. It is known that acceptable storage characterisitics may however be obtained through the protection of the carbonate by coating the crystalline product, or by the inclusion of stabilizing agents during its manufacture, or both. A variety of suitable coating agents have been proposed including silicates and mixtures of inorganic sulphate and carbonate salts.

There is still, however, the need to improve storage stability of the percarbonate bleach, to achieve this in all types of detergent compositions, including compositions made by the various making processes now available.

The problem of the influence of free moisture level on percarbonate stability has been addressed in EPA503 221 by specifying to keep the level of Equilibrium Relative Humidity under 30% at 32° C.; it was found however that, while the moisture level can relatively be well controlled upon making of the detergent composition, it is quite difficult to control its evolution during storage, where moisture is almost inevitably picked up.

It has also been found that packaging such percarbonate-containing compositions in water-proof materials does not provide an acceptable solution to the percarbonate stability problem, since the influence of temperature on percarbonate stability is not controlled by such packages; in fact, in a high temperature environment, such devices have been found to accelerate the decomposition of percarbonate.

It has now been found that the storage stability of percarbonate can be quite satisfactorily controlled not only in high moisture but also in high temperature environments, by the combination of the selected Equilibrium Relative Humidity level in the detergent compositions and a package with selected characteristics.

### SUMMARY OF THE INVENTION

The combination of a granular detergent composition containing a percarbonate bleaching agent with a packaging system containing said composition, characterized in that said composition has a Equilibrium Relative Humidity below 30%, at 35° C., and that the packaging system contains at least one unit having a Moisture Vapour Transfer Rate of from 1 g/m²/day to less than 20 g/m²/day.

### DETAILED DESCRIPTION OF THE INVENTION

The detergent composition

By the term detergent composition herein is meant laundry detergent compositions, as well as automatic dishwashing compositions and laundry additive compositions.

The present compositions are characterized by their Equilibrium Relative Humidity, of no more than 30% by weight at 35° C.

For the purposes of the present invention, Equilibrium Relative Humidity is measured as follows: 300 g of product is placed in a 1 liter container made of a water impermeable material and fitted with a lid capable of sealing the containers. The lid is provided with a sealable hole adapted to allow insertion of a probe into the container interior. The container and contents are maintained at a temperature of 35° C. for 24 hours to allow temperature equilibration. A solid state Hygrometer (Hygrotest 6100, marketed by Testoterm Ltd, Old Flour Mill, Queen Street, Emsworth, Hampshire, England) is used to measure the water vapour pressure in the space over the products. Whilst the container is maintained at 35° C., the probe is inserted through the hole in the lid and measurements of the water vapour pressure are made at ten minute intervals until the vapour pressure has equilibrated, as evidenced by no change in two successive readings. The instrument converts the water vapour in two successive readings. The instrument converts the water vapour pressure measurement into a direct read-out of the Equilibrium Relative Humidity.

The compositions of the present invention can be prepared in a variety of ways so as to display an Equilibrium Relative Humidity of not more than the critical value of 30% at 35° C.

For example, certain of the components of laundry detergent compositions which contain intrinsic moisture such as surfactant agglomerates or spray dried components, can be dried or further dried prior to mixing; dried zeolite can also be used in the preparation of surfactant agglomerates, as dry add, in spray-dried components, or in a final dusting step.

Other ways include the drying of finished product such as described in DE 40 31 910.

Some ways/executions may lead to Equilibrium Relative Humidity values below 25% at 35° C.

The percarbonate particles

The compositions herein contain from 1% to 40%, preferably from 3% to 30% by weight, most preferably from 5% to 25% by weight of an alkali metal percarbonate bleach; in the form of particles having a mean size from 250 to 900 micrometers, preferably 500 to 700 micrometers.

When the compositions herein are laundry additives, the level of percarbonate is from 20% to 80% by weight.

The alkali metal percarbonate bleach is usually in the form of the sodium salt. Sodium percarbonate is an addition compound having a formula corresponding to 2Na₂CO₃ 3H₂O₂. to enhance storage stability the percarbonate bleach can be coated with a further mixed salt of an alkali metal sulphate and carbonate. Such coatings together with coating processes have previously been described in GB-1,466,799, granted to Interox on Mar. 9, 1977. The weight ratio of the mixed salt coating material to percarbonate lies in the range from 1:2000 to 1:4, more preferably from 1:99 to 1:9, and most preferably from 1:49 to 1:19. Preferably, the mixed salt is of sodium sulphate and sodium carbonate which as the genral formula Na2SO4.n.Na2CO3 wherein n is from 0.1 to 3, preferably n is from 0.3 to 1.0 and most preferably n is from 0.2 to 0.5.

Other suitable coating materials are sodium silicate, of 155: SiO2:Na2O ratio from 1.6:1 to 2.8:1, and magnesium silicate.

Commercially available carbonate/sulphate coated percarbonate bleach may include a low level of a heavy metal sequestrant such as EDTA, 1-hydroxyethylidene 1,1-diphosphonic acid (HEDP) or an aminophosphonate, that is incorporated during the manufacturing process.

The packaging system

The packaging system containing the detergent compositions of the present invention is characterized in that it contains at least one unit having a Moisture Vapour Transfer Rate, in the range of from 1 g/m²/day to less than 20 g/m²/day, preferably 1 g/m²/day to 15 g/m²/day.

The Moisture Vapour Transfer Rate can be measured by known methods such as described in ASTM Standard E-96-53T, test for measuring Water Vapor transmission of Materials in Sheet form, and TAPPI Standard T464 m-45, Water Vapor Permeability of Sheet Materials at high temperature and Humidity.

The method used in the context of the present invention is referred to as the procon test, using a Permatran-W TWIN equipment.

The procedure is as follows:

Equipment

Aluminium test cups with lids (4″ and 6″ diameter)

Template 1 (for cutting sample)

Template 2 (for applying wax)

Electric hotplate

Laboratory oven with temperature control (accuracy ±1 degree C.)

Laboratory cabinet with humidity control (accuracy ±2% R.H.)

Microcrystalline wax (c.g. Mobel Oil Wax 2305 or equivalent)

Calcium chloride, anhydrous, granular, 8 mesh

Petrolatum

Electric vessel with thermostat for melting wax

Cutting pad

Scissors or circular cutting knife

Laboratory balance (i.e. Mettler K-7, Mikrowa type FW-31-6, etc.) with accuracy of ±0.05 g.

Preparation of materials

A test sample is cut out from the material to be tested. Another test sample from uniform protective sheet of material of known MVTR is used as control (e.g. bitumen laminated liner or wax-laminated board).

Test procedure

1) The wax is heated in the electric vessel to 90-110° C. The test cups are heated in the oven or hot plate for ½ hour at about 90° C. One test cup is removed from the oven at a time, and the cups are filled with calcium chloride up to ⅔ of cup ring height, petrolatum is applied sparingly to the beveled edge of the template 2. The base of the template 2 is wiped dry where it comes in contact with the test sample. The sample is centered in the cup. The template 2 is placed over the sample and centered with respect to the cup. Melted wax is poured into the annular space formed by the beveled edge of the template 2 and the cup rim. When the wax has solidified, the template 2 is removed using a gentle twisting motion. The cup assembly is weighted to the nearest 0.05 gram before being placed in the test atmosphere. The cups are stored at 35° C./80% eRH.

2) After being left two days in the humidity cabinet, the cups are weighed every 24 hours interval until a constant weight gain is obtained on three successive weighings (maximum deviation 0.25 gram). The cups are weighed immediately after removal from the humidity cabinet, and are covered with an aluminium lid when moved from cabinet to balance.

All weighings are recorded and the daily weight gain for each cup is calculated. The MVTR is recorded in g/m²/24 hours and calculated as follows:

a) effective area of sample: 66.6 cm² (4″ diameter cups)

$$36000 \times \frac{x}{y} g / {m}^{2} / 24 hours$$

b) effective area of sample: 133 cm² (6″ diameter cups)

$$1800 \times \frac{x}{y} g / {m}^{2} / 24 hours$$

where x=total weight gain in grams

y=time in hours

(both calculated on the basis of 3 successive periods with a daily constant weight gain)

The packaging system herein consists of at least one unit being the recipient for the compositions of the present invention; such a unit is typically a consumer unit such as a bag/pouch, or a board packet carton or drum containing the composition of the invention and designed to be used/stored as such in the consumer homes.

If such a unit already achieves the Moisture Vapour Transfer Rate characteristics of the present invention, it can be used alone and therefore can constitute the packaging system of the present invention.

It is however possible that the Moisture Vapour Transfer Rate characteristics therein be achieved via an outer packaging unit protecting the consumer unit, for e.g. shipping purposes. In such a case the packaging system herein may consist of a consumer unit and one on more external units, said external units being made of plastic and/or paper laminates or board. Those materials are described more in detail herebelow.

The packaging system herein may also consist of a plurality of consumer units grouped for shipping convenience in e.g. bundles; in such a case the external unit will typically be a plastic wrapper combined with a board tray holding said consumer units together.

Depending on the execution of the present system, the amount of detergent composition contained in the packaging systems herein can vary from 250 g (individual small consumer units) to 20 kg, (bundles consumer units).

The consumer units of the present packaging systems are preferably bags/pouches, and such units are typically used in refill bags.

Refill bags are readily collapsible containers which have been designed in order to reduce the amount of plastic packaging material disposed in the environment;

Refill bags can be used by emptying their content into a permanent package such as plastic or metal cannister or a carton container that the consumer uses for storing the detergent products;

In such an execution the refill bag is not reclosable; however, reclosable bags/pouches are encompassed by the present invention as well.

The bags/pouches herein can be pillow bags or gusseted bags; either ones, but specifically the gusseted bags, may have reduced or no head space; they can be made either from raw stock or from preformed and/or prefolded material, and can be sealed by various means, e.g. by heat, adhesives/glue, tapes.

The bags/pouches herein are made of films, either monolayer, including coextruded materials, or laminated; such films are typically paper or plastic or combinations of the two; preferred materials for the bags herein are plastic and/or paper laminates. Plastic, materials are typically polyolefines, and both plastic and paper can be virgin or recycled material; the films herein can be printed in different ways, typically gravure, flexo, offset.

Also encompassed herein are films with moisture barrier properties, obtained by resins, either coextruded or in different laminated layers, or coating by e.g. lacquers.

The consumer units herein can also consist of board cartons/packets/drums, used of either corrugated or laminated materials, or combinations of the two, said materials being either virgin or recycled;

Said cartons/packets/drums can, if necessary in view of obtaining the derived Moisture Vapour Transfer Rate, be coated either on the inside on to the outside with a layer of material, typically metal or plastic laminate, providing to the unit the Moisture Vapour Transfer Rate characteristics of the invention.

The cartons/packets/drums herein can be printed as described above, and/or be coated with materials such as lacquers ensuring barrier properties.

Anionic Surfactants

In the preferred embodiment herein, where the detergent compositions herein is a laundry detergent composition, compositions of the present invention usually contain one or more anionic surfactants as described below.

Alkyl Sulfate Surfactant

Alkyl sulfate surfactants hereof are water soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quarternary ammonium cations derived from alkylamines such as ethylamine, diethylamine, triethylamine, and mixtures thereof, and the like). Typically, alkyl chains of C₁₂₋₁₆ are preferred for lower wash temperatures (e.g., below about 50° C.) and C₁₆₋₁₈ alkyl chains are preferred for higher wash temperatures (e.g., above about 50° C.).

Alkyl Alkoxylated Sulfate Surfactant

Alkyl alkoxylated sulfate surfactants hereof are water soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 5, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulfate, C₁₂-C₁₈E(1.0)M), C₁₂-C₁₈ alkyl polyethoxylate (2.25) sulfate, C₁₂-C₁₈E(2.25)M), C₁₂-C₁₈ alkyl polyethoxylate (3.0) sulfate C₁₂-C₁₈E(3.0), and C₁₂-C₁₈ alkyl polyethoxylate (4.0) sulfate C₁₂-C₁₈E(4.0)M), wherein M is conveniently selected from sodium and potassium.

Other Anionic Surfactants

Other anionic surfactants useful for detersive purposes can also be included in the laundry detergent compositions of the present invention with or without the species described above. These can include salts (including, for example, sodium, potassium, ammonium, and substituted ammonium salts such as mono-, di- and triethanolamine salts) of soap, C₉-C₂₀ linear alkylbenzenesulphonates, C₈-C₂₂ primary or secondary alkanesulphonates, C₈-C₂₄ olefinsulphonates, sulphonated polycarboxylic acids prepared by sulphonation of the pyrolyzed product of alkaline earth metal citrates, e.g., as described in British patent specification No. 1,082,179, C₈-C₂₄ alkylpolyglycolethersulfates (containing up to 10 moles of ehtylene oxide); alkyl ester sulfonates such as C₁₄₋₁₆ methyl ester sulfonates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO—M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23 (herein incorporated by reference).

Preferred surfactants for use in the compositions herein are the alkyl sulfates, alkyl alkoxylated sulfates, and mixtures thereof.

When included therein, the laundry detergent compositions of the present invention typically comprise from about 1% to about 40%, preferably from about 3% to about 20% by weight of such anionic surfactants.

Nonionic Surfactants

The present laundry detergent compositions preferably also comprise a nonionic surfactant.

While any nonionic surfactant may be normally employed in the present invention, two families of nonionics have been found to be particularly useful. These are nonionic surfactants based on alkoxylated (especially ethoxylated) alcohols, and those nonionic surfactants based on amidation products of fatty acid esters and N-alkyl polyhydroxy amine. The amidation products of the esters and the amines are generally referred to herein as polyhydroxy fatty acid amides. Particularly useful in the present invention are mixtures comprising two or more nonionic surfactants wherein at least one nonionic surfactant is selected from each of the groups of alkoxylated alcohols and the polyhydroxy fatty acid amides.

Suitable nonionic surfactants include compounds produced by the condensation of alkylene oxide groups (hydrophilic in nature) with an organic hydrophobic compound, which may be aliphatic or alkyl aromatic in nature. The length of the polyoxyalkylene group which is condensed with any particular hydrophobic group can be readily adjusted to yield a water-soluble compound having the desired degree of balance between hydrophilic and hydrophobic elements.

Particularly preferred for use in the present invention are nonionic surfactants such as the polyethylene oxide condensates of alkyl phenols, e.g., the condensation products of alkyl phenols having an alkyl group containing from about 6 to 16 carbon atoms, in either a straight chain or branched chain configuration, with from about 4 to 25 moles of ethylene oxide per mole of alkyl phenol.

Preferred nonionics are the water-soluble condensation products of aliphatic alcohols containing from 8 to 22 carbon atoms, in either straight: chain or branched configuration, with an average of up to 25 moles of ethylene oxide per more of alcohol. Particularly preferred are the condensation products of alcohols having an alkyl group containing from about 9 to 15 carbon atoms with from about 2 to 10 moles of ethylene oxide per mole of alcohol; and condensation products of propylene glycol with ethylene oxide. Most preferred are condensation products of alcohols having an alkyl group containing from about 12 to 15 carbon atoms with an average of about 3 to 7 moles of ethylene oxide per mole of alcohol, preferably 3 to 5.

The nonionic surfactant system herein can also include a polyhydroxy fatty acid amide component.

Polyhydroxy fatty acid amides may be produced by reacting a fatty acid ester and an N-alkyl polyhydroxy amine. The preferred amine for use in the present invention is N—(R1)—CH2(CH2OH)4—CH2—OH and the preferred ester is a C12-C20 fatty acid methyl ester. Most preferred is the reaction product of N-methyl glucamine with C12-C20 fatty acid methyl ester.

Methods of manufacturing polyhydroxy fatty acid amides have been described in WO 92 6073, published on Apr. 16, 1992. This application describes the preparation of polyhydroxy fatty acid amides in the presence of solvents. In a highly preferred embodiment of the invention N-methyl glucamine is reacted with a C12-C20 methyl ester. It also says that the formulator of granular detergent compositions may find it convenient to run the amidation reaction in the presence of solvents which comprise alkoxylated, especially ethoxylated (EO 3-8) C12-C14 alcohols (page 15, lines 22-27). This directly yields nonionic surfactant systems which are preferred in the present invention, such as those comprising N-methyl glucamide and C12-C14 alcohols with an average of 3 ethoxylate groups per molecule.

Nonionic surfactant systems, and granular detergents made from such systems have been described in WO 92 6160, published on Apr. 16, 1992. This application describes (example 15) a granular detergent composition prepared by fine dispersion mixing in an Eirich RV02 mixer which comprises N-methyl glucamide (10%), nonionic surfactant (10%).

Both of these patent applications describe nonionic surfactant systems together with suitable manufacturing processes for their synthesis, which have been found to be suitable for use in the present invention.

The polyhydroxy fatty acid amide may be present in compositions of the present invention at a level of from 0% to 50% by weight of the detergent component or composition, preferably from 5% to 40% by weight, even more preferably from 10% to 30% by weight.

Also useful as the nonionic surfactant of the surfactant systems of the present invention are the alkylpolysaccharides disclosed in U.S. Pat. No. 4,565,647, Llenado, issued Jan. 21, 1986, having a hydrophobic group containing from about 6 to about 30 carbon atoms, preferably from about 10 to about 16 carbon atoms and a polysaccharide, e.g. a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g., glucose, galactose and galactosyl moieties can be substituted for the glucosyl moieties (optionally the hydrophobic group is attached at the 2-, 3-, 4-, etc. positions thus giving a glucose or galactose as opposed to a glucoside or galactoside). The intersaccharide bonds can be, e.g., between the one position of the additional saccharide units and the 2-, 3-, 4-, and/or 6-positions on the preceding saccharide units.

The preferred alkylpolyglycosides have the formula

R²O(CₙH₂ₙO)ₜ(glycosyl)ₓ

wherein R² is selected from the group consisting of alkyl, alkylphenyl, hydroxyalkyl, hydroxyalkylphenyl, and mixtures thereof in which the alkyl groups contain from about 10 to about 18, preferably from about 12 to about 14, carbon atoms; n is 2 or 3, preferably 2; t is from 0 to about 10, preferably from about 1.3 to about 3, most preferably from about 1.3 to about 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantely the 2-position.

Other Surfactants

The laundry detergent compositions of the present invention may also contain cationic, ampholytic, zwitterionic, and semi-polar surfactants, as well as nonionic surfactants other than those already described herein, including the semi-polar nonionic amine oxides described below.

Cationic detersive surfactants suitable for use in the laundry detergent compositions of the present invention are those having one long-chain hydrocarbyl group. Examples of such cationic surfactants include the ammonium surfactants such as alkyldi- or tri-methylammonium compounds, and those surfactants having the formula

[R²(OR³)y][R⁴(OR³)y]₂R⁵N+X−

wherein R2 is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂COH—CHOHCOR⁶CHOHCH₂OH wherein R6 is any hexose or hexose polymer having a molecular weight less than about 1000, and hydrogen when y is not 0; R⁵ is the same as R⁴ or is an alkyl chain wherein the total number of carbon atoms of R2 plus R⁵ is not more than about 18; each y is from 0 to about 10 and the sum of the y values is from 0 to about 15; and X is any compatible anion.

Other cationic surfactants useful herein are also described in U.S. Pat. No. 4,228,044, Caubre, issued Oct. 14, 1980, incorporated herein by reference.

When included therein, the laundry detergent compositions of the present invention typically comprise from 0% to about 25%, preferably form about 3% to about 15% by weight of such cationic surfactants.

Ampholytic surfactants are also suitable for use in the laundry detergent compositions of the present invention. These surfactants can be broadly described as aliphatic derivatives of secondary or tertiary amines, or aliphatic derivatives of heterocyclic secondary and tertiary amines in which the aliphatic radical can be straight- or branched chain. One of the aliphatic substituents contains at least 8 carbon atoms, typically from about 8 to about 18 carbon atoms, and at least one contains an anionic water-solubilizing group e.g. carboxy, sulfonate, sulfate. See U.S. Pat. No. 3,929,678 to Laughlin et al., issued Dec. 30, 1975 at column 19, lines 18-35 (herein incorporated by reference) for examples of ampholytic surfactants.

When included therein, the laundry detergent compositions of the present invention typically comprise form 0% to about 15%, preferably from about 1% to about 10% by weight of such ampholytic surfactants.

Zwitterionic surfactants are also suitable for use in laundry detergent compositions. These surfactants can be broadly described as derivatives of secondary and tertiary amines, derivates of heterocyclic secondary and tertiary amines, or derivatives of quaternary ammonium, quarternary. phosphonium or tertiary sulfonium compounds. See U.S. Pat. No. 3,929,678 to Laughlin et al., issued Dec. 30, 1975 at columns 19, line 38 through column 22, line 48 (herein incorporated by reference) for examples of zwitterionic surfactants.

When included therein, the laundry detergent compositions of the present invention typically comprise form 0% to about 15%, preferably from about 1% to about 10% by weight of such zwitterionic surfactants.

Semi-polar nonionic surfactants are a special category of nonionic surfactants which include water-soluble amine oxides containing one alkyl moiety of from about 10 to about 18 carbon atoms and 2 moieties selected from the group consisting af alkyl groups and hydrocyalkyl groups containing form about 1 to about 3 carbon atoms; water-soluble phosphine oxides containing one alkyl moiety of form about 10 to about 18 carbon atoms and 2 moieties selected form the group consisting of alkyl groups and hydroxyalkyl groups containing from about 1 to about 3 carbon atoms.

Semi-polar nonionic detergent surfactants include the amine oxide surfactants having the formula:

O

R³ (OR⁴)xN(R⁵)₂

Builder

The laundry detergent compositions and automatic dishwashing compositions herein contain a builder, preferably non-phosphate detergent builders, although phosphate-containing species are not excluded in the content of the present invention. These can include, but are not restricted to alkali metal carbonates, bicarbonates, silicates; aluminosilicates, carboxylates and mixtures of any of the foregoing. The builder system is present in an amount of from 1% to 80% by weight of the composition, typically preferable from 20% to 60% by weight in granular laundry detergent compositions herein, and from 1% to 30% in liquid laundry detergent compositions herein.

Suitable silicates are those having an SiO₂:Na₂O ratio in the range from 1.6 to 3.4, the so-called amorphous silicates of SiO₂:Na₂O ratios from 2.0 to 2.8 being preferred.

Within the silicate class, highly preferred materials are crystalline layered sodium silicates of general formula

NaMSiₓO₂ₓ+1.yH2O

wherein M is sodium or hydrogen, x is a number from 1.9 to 4 and y is a number from 0 to 20. Crystalline layered sodium silicates of this type are disclosed in EP-A-0164514 and methods for their preparation are disclosed in DE-A-3417649 and DE-A-3742043. For the purposes of the present invention, x in the general formula above has a value of 2, 3 or 4 and is preferably 2. More preferably M is sodium and y is 0 and a preferred example of this formula comprise the form of Na₂Si₂O₅. These materials are available from Hoechst AG FRG as respectively NaSKS-5, NaSKS-7, NaSKS-11 and NaSKS-6. The most preferred material is —Na₂Si₂O₅, NaSKS-6. Crystalline layered silicates are incorporated either as dry mixed solids, or as solid components of agglomerates with other components.

Whilst a range of aluminosilicate ion exchange materials can be used, preferred sodium aluminosilicate zeolites have the unit cell formula

Na_{z}[(AlO₂)_{z}.(SiO₂)_{y}]xH₂O

wherein z and y are at least about 6, the molar ratio of z to y is from about 1.0 to about 0.4 and z is from about 10 to about 264. Amorphous hydrated aluminosilicate materials useful herein have the empirical formula

M_{z}(zAlO₂.ySiO₂)

wherein M is sodium, potassium, ammonium or substituted ammonium, z is from about 0.5 to about 2 and y is 1, said material having a magnesium ion exchange capacity of at least about 50 milligram equivalents of CaCO₃ hardness per gram of anhydrous aluminosilicate. Hydrated sodium Zeolite A with a particle size of from about 0.01 to 10 microns is preferred.

The aluminosilicate ion exchange builder materials herein are in hydrated form and contain from about 10% to about 28% of water by weight if crystalline, and potentially even higher amounts of water if amorphous. Highly preferred crystalline aluminosilicate ion exchange materials contain from about 18% to about 22% water in their crystal matrix. The crystalline aluminosilicate ion exchange materials are further characterized by a particle size diameter of from about 0.1 micron to about 10 microns. Amorphous materials are often smaller, e.g., down to less than about 0.01 micron. Preferred ion exchange materials have a particle size diameter of from about 0.2 micron to about 4 microns. The term “particle size diameter” herein represents the average particle size diameter by weight of a given ion exchange material as determined by conventional analytical techniques such as, for example, microscopic determination utilizing a scanning electron microscope.

Aluminosilicate ion exchange materials useful in the practice of this invention are commercially available. The aluminosilicates useful in this invention can be crystalline or amorphous in structure and can be naturally occurring aluminosilicates or synthetically derived. A method for producing aluminosilicate ion exchange materials is discussed in U.S. Pat. No. 3,985,669, Krummel et al., issued Oct. 12, 1976, incorporated herein by reference. Preferred synthetic crystalline aluminosilicate ion exchange materials useful herein are available under the designations Zeolite A, Zeolite X, P and MAP, the latter species being described in EPA 384 070. In an especially preferred embodiment, the crystalline aluminosilicate ion exchange material is a Zeolite A having the formula

Na₁₂[(AlO₂)₁₂(SiO2)₁₂].xH₂O

wherein x is from about 20 to about 30, especially about 27 and has a particle size generally less than about 5 microns.

Suitable carboxylate builders containing one carboxy group include lactic acid, glycollic acid and ether derivatives thereof as disclosed in Belgian Patent Nos. 831,368, 821,369 and 821,370. Polycarboxylates containing two carboxy groups include the water-soluble salts of succinic acid, malonic acid, (ethylenedioxy) diacetic acid, maleic acid, diglycollic acid, tartaric acid, tartronic acid and fumaric acid, as well as the ether carboxylates described in German Offenlegenschrift 2,446,686 and 2,446,687 and U.S. Pat. No. 3,935,257 and the sulfinyl carboxylates described in Belgian Patent No. 840,623. Polycarboxylates containing three carboxy groups include, in particular, water-soluble citrates, aconitrates and citraconates as well as succinate derivatives such as the carboxymethyloxysuccinates described in British Patent No. 1,379,241, lactoxysuccinates described in Netherlands Application 7205873, and the oxypolycarboxylate materials such as 2-oxa-1,1,3-propane tricarboxylates described in British Patent No. 1,387,447.

Polycarboxylates containing four carboxy groups include oxydisuccinates disclosed in British Patent No. 1,261,829,1, and the 1,2,2-ethane tetracarboxylates ,1,1,3,3-propane tetracarboxylates and 1,1,2,3-propane tetracarboxylates. Polycarboxylates containing sulfo substituents include the sulfosuccinate derivatives disclosed in British Patent Nos. 1,398,421 and 1,398,422 and in U.S. Pat. No. 3,936,448, and the sulfonated pyrolysed citrates described in British Patent No. 1,082,179, while polycarboxylates containing phosphone substituents are disclosed in British Patent No. 1,439,000.

Alicyclic and heterocyclic polycarboxylates include cyclopentane-cis,cis,cis-tetracarboxylates, cyclopentadienide pentacarboxylates, 2,3,4,5-tetrahydrofuran-cis,cis,cis-tetracarboxylates, 2,5-tetrahydrofuran-cis-dicarboxylates, 2,2,5,5,-tetrahydrofuran -tetracarboxylates, 1,2,3,4,5,6-hexane hexacarboxylates and carbxoymethyl derivatives of polyhydric alcohols such as sorbitol, mannitol and xylitol. Aromatic polycarboxylates include mellitic acid, pyromellitic: acid and the phtalic acid derivates disclosed in British Patent No. 1,425,343.

Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylenediaminetetracetates, N-hydroxyethylethylenediaminetriacetates, nitrilotriacetates, ethylenediamine tetraprionates, triethylenetetraaminehexacetates, diethylenetriaminepentaacetates, and ethanoldiglycines, alkali metal, ammonium, and substituted ammonium salts therein and mixtures therein.

Amino phosphonates are also suitable for use as chelating agents in the compositions of the invention when at least low levels of total phosphorous are permitted in detergent compositons, and include ethylenediaminetetrakis (methylenephosphonates) as DEQUEST. Preferred, these amino phosphonates do not contain alkyl or alkenyl groups with more than about 6 carbon atoms.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelator for use herein is ethyelediamine disuccinate (“EDDS”), especially the [S,S] isomer as described in U.S. Pat. No. 4,704,233, Nov. 3, 1987, to Hartman and Perkins.

If utilized, these chelating agents will generally comprise from about 0.1% to about 10% by weight of the detergent compositions herein. More preferably, if utilized, the chelating agents will comprise from about 0.1% to about 3.0% by weight of such compositions.

Of the above, the preferred polycarboxylates are hydroxycarboxylates containing up to three carboxy groups per molecule, more particularly citrates.

The granular detergent compositions and automatic dishwashing compositions herein have a pH above 8.5, preferably in the range of from 9 to 11.

The present laundry granular compositions are preferably in a compact form, having a bulk density of at least 650 g/l, preferably at least 750 g/l, but can also be in a conventional form, with densities in a range of from 200 g/l to 700 g/l.

In another embodiment of the invention, are provided Automatic Dishwashing Compositions: Automatic dishwashing compositions typically contain, in addition to percarbonate a builder, such as described above, a source of alkalinity, such as silicate or carbonate, those ingredients amounting to up to 70% of the formulation. Optional ingredients include polymers and enzymes.

In still another embodiment of the invention, are provided Laundry Additive Compositions: such compositions typically contain the bleaching agent at levels of from 15 to 80% by weight.

Optional Ingredients

Other ingredients which are known for use in detergent compositions may also be used as optional ingredients in the various embodiments of the present invention, such as bleach activators, bleach catalysts, other bleaching agents, polymers, enzymes, suds suppressing agents, fabric softening agents, in particular fabric softening clay, as well as dyes, fillers, optical brighteners, pH adjusting agents, non builder alkalinity sources, enzyme stability agents, hydrotopes, solvents, perfumes.

Bleach activators

The present compositions, especially the granular laundry detergent compositions and laundry additives described above, preferably contain from 1% to 20% by weight of the composition, preferably from 2% to 15% by weight, most preferably from 3% to 10% by weight of a peroxyacid bleach activator, in addition to the percarbonate bleaching agent described above.

Peroxyacid bleach activators (bleach precursors) as additional bleaching components in accordance with the invention can be selected from a wide range of class and are preferably those containing one or more N-or O-acyl groups.

Suitable classes include anhydrides, esters, amides, and acylated derivatives of imidazoles and oximes, and examples of useful materials within these classes are disclosed in GB-A-1586789. The most preferred classes are esters such as are disclosed in GB-A-836 988, 864,798, 1 147 871 and 2 143 231 and amides such as are disclosed in GB-A-855 735 and 1 246 338.

Particularly preferred bleach activator compounds as additional bleaching components in accordance with the invention are the N-,N,N′N′ tetra acetylated compounds of the formula

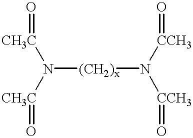

where x can be 0 or an integer between 1 and 6.

Examples include tetra acetyl methylene diamine (TAMD) in which x=1, tetra acetyl ethylene diamine (TAED) in which x=2 and Tetraacetyl hexylene diamine (TAHD) in which x=6. These and analogous compounds are described in GB-A-907 356. The most preferred peroxyacid bleach activator as an additional bleaching component is TAED.

Another preferred class of peroxyacid bleach compounds are the amide substituted compounds of the following general formulae:

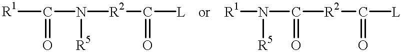

wherein R¹ is an aryl or alkaryl group with from about 1 to about 14 carbon atoms, R² is an alkylene, arylene, and alkarylene group containing from about 1 to about 14 carbon atoms, and R⁵ is H or an alkyl, aryl, or alkaryl group containing 1 to 10 carbon atoms and L can be essentially any leaving group. R¹ preferably contains from about 6 to 12 carbon atoms. R² preferably contains from about 4 to 8 carbon atoms. R¹ may be straight chain or branched alkyl, substituted aryl or alkylaryl containing branching, substitution, or both and may be sourced from either synthetic sources or natural sources including for example, tallow fat. Analogous structural variations are permissible for R². The substitution can include alkyl, aryl, halogen, nitrogen, sulphur and other typical substituent groups or organic compounds. R⁵ is preferably H or methyl. R¹ and R⁵ should not contain more than 18 carbon atoms total. Amide substituted bleach activator compounds of this type are described in EP-A-0170386.

Another class of bleach activators to use in combination with percarbonate comprises C₈, C₉, and/or C₁₀ (6-octanamidocaproyl) oxybenzenesulfonate, 2-phenyl-(4H)3,1 benzoxazin-4-one, benzoyllactam preferably benzoylcaprolactam and nonanoyl lactam preferably nonanoyl caprolactam.

Bleaching agents

The granular laundry detergent, automatic dishwashing compositions or laundry additives herein may contain an additional bleaching agent, in addition to the percarbonate of the present invention.

The additional bleaching agent, if used, is either an inorganic persalt such as perborate, persulfate, or a preformed organic peracid or perimidic acid, such as N,N phtaloylaminoperoxy caproic acid, 2-carboxy-phtaloylaminoperoxy caproic acid, N,N phtaloylaminoperoxy valeric acid, Nonyl amide of peroxy adipic acid, 1,12 diperoxydodecanedoic acid, Peroxybenzoic acid and ring substituted peroxybenzoic acid, Monoperoxyphtalic acid (magnesium salt, hexhydrate), Diperoxybrassylic acid.

Polymers

Also useful are various organic polymers, some of which also may function as builders to improve detergency. Included among such polymers may be mentioned sodium carboxy-lower alkyl celluloses, sodium lower alkyl celluloses and sodium hydroxy-lower alkyl celluloses, such as sodium carboxymethyl cellulose, sodium methyl cellulose and sodium hydroxypropyl cellulose, polyvinyl alcohols (which often also include some polyvinyl acetate), polyacrylamides, polyacrylates and various copolymers, such as those of maleic and acrylic acids. Molecular weights for such polymers vary widely but most are within the range of 2,000 to 100,000. Also useful are terpolymers of maleic/acrylic acid and vinyl alcohol having a molecular weight ranging from 3.000 to 70.000.

Polymeric polycarboxylate builders are set forth in U.S. Pat. No. 3,308,067, Diehl, issued Mar. 7, 1967. Such materials include the water-soluble salts of homo-and copolymers of aliphatic carboxylic acids such as maleic acid, itaconic acid, mesaconic acid, fumaric acid, aconitic acid, citraconic acid and methylenemalonic acid.

Polyaspartate and polyglutamate dispersing agents may be used, especially with zeolite builders. Dispersing agents such as polyasparatate preferably have a molecular weight of about 10,000.

Other useful polymers include species known as soil release polymers, such as described in EPA 185 427 and EPA 311 342.

Still other polymers suitable for use herein include dye transfer inhibition polymers such as polyvinylpyrrolidone, polyvinylpyrridine, N-oxide, N-vinylpyrrolidone, N-imidazole, polyvinyloxozolidone or polyvinylimidazole.

Enzymes

Enzymatic materials can be incorporated into the detergent compositions herein. Suitable are proteases, lipases, cellulases, peroxidases, amylases and mixtures thereof.

A suitable lipase enzyme is manufactured and sold by Novo Industries A/S (Denmark) under the trade name Lipolase and mentioned along with other suitable lipases in EP-A-0258068 (Novo Nordisk).

Suitable cellulases are described in e.g. WO-91/17243 and WO 91/17244 (Novo Nordisk).

Preferred commercially available protease enzymes include those sold under the trade names Alcalase and Savinase by Novo Industries A/S (Denmark) and Maxatase by International Bio-Synthetics, Inc. (The Netherlands).

Other proteases include Protease A (see European Patent Application 130 756, published Jan. 9, 1985) and Protease B (see European Patent Application Serial No. 87303761.8, filed Apr. 28, 1987, and European Patent Application 130 756, Bott et al, published Jan. 9, 1985).

Peroxidase enzymes are used in combination with oxygen sources, e.g. percarbonate, perborate, persulfate, hydrogen peroxide, etc. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase. Peroxidase-containing detergent compositions are disclosed, for example, in PCT International Application WO 89/099813 and in WO 91/05839.

Amylases include, for example, -bacterial amylases obtained from a special strain of B. licheniforms, described in more detail in GB-1,296,839 (Novo). Preferred commercially available amylases include for example, Rapidase, sold by International Bio-Synthetics Inc. and Termamyl, sold by Novo Nordisk A/S. Fungal amylases such as Fungamyl® amylase, sold by Novo Nordisk, can also be used.

Preferred process for making the laundry detergent composition herein.

In a preferred process for making the laundry detergent compositions of the present invention, in particular when a high bulk density is desired, part or all of the surfactant contained in the finished composition is incorporated in the form of separate particles; said particles may take the form of flakes, prills, marumes, noodles, ribbons, but preferably take the form of granules, The most preferred way to process the particles is by agglomerating powders (such as e.g. aluminosilicate, carbonate) with high active surfactant pastes and to control the particle size of the resultant agglomerates within specified limits. Such a process involves mixing an effective amount of powder with a high active surfactant paste in one or more agglomerators such as a pan agglomerator, a Z-blade mixer or more preferably an in-line mixer such as those manufactured by Schugi (Holland) BV, 29 Chroomstraat 8211 AS, Lelystad, Netherlands, and Gebruder Lodige Maschinenbau GmbH, D-4790 Paderborn 1, Elsenerstrasse 7-9, Postfach 2050, Germany. Most preferably a high shear mixer is used, such as a Lodige CB (Trade Name).

A high active surfactant paste comprising from 50% by weight to 95% by weight, preferably 70% by weight to 85% by weight of surfactant is used. The surfactant system may comprise any of the groups of anionic, nonionic, cationic, amphoteric, and zwitterionic surfactants, or mixtures of these. The paste may be pumped into the agglomerator at a temperature high enough to maintain a pumpable viscosity, but low enough to avoid degradation of the anionic surfactants used. An operating temperature of the paste of 50° C. to 80° C. is typical.

A particularly suitable process of making surfactant particles from high active surfactant; pastes is more fully described in EP 510 746, published on Oct. 28, 1992.

The free-flowing surfactant particles made by the process described above are then mixed with other detergent components, such as the particles containing the alkalimetal percarbonate in order to produce a finished detergent composition.

This mixing may take place in any suitable piece of equipment. Liquid detergents such as nonionic surfactant and perfume may be sprayed on to the surface of one or more of the constituent granules, or onto the finished composition.

### EXAMPLES

### Example I

The following granular laundry detergent composition was prepared:

| | % by weight |
|---|---|
| Anionic surfactant agglomerate* | 30 |
| Layered silicate compacted granule | 18 |
| (supplied by Hoechst under trade name SKS-6) | |
| Percarbonate** | 25 |
| TAED agglomerate | 9 |
| Suds suppressor agglomerate | 2 |
| Perfume encapsulate | 0.2 |
| Granular dense soda ash | 8.4 |
| Granular acrylic-maleic copolymer | 3.2 |
| Enzymes | 3.6 |
| Granular soil release polymer | 0.6 |
| | 100 |

*Anionic surfactant agglomerates were made from a 78% active surfactant paste which comprises C45AS/C35AE3S (alkyl sulfate/alkyl ethoxy sulfate) in the ratio of 80:20. The paste was agglomerates with a powder mixture according to the process described in EPA 510 746. The resulting anionic surfactant granule had a composition of 30% C45AS, 7.5% C35AE3S, 24% zeolite, 20% carbonate, 2.5% CMC, 12% acrylic-maleic co-polymer, and the balance of moisture.
**Percarbonate coated with 2.5% carbonate/sulphate with mean particle size of 500 microns.

The mixture of granular ingredients listed above was placed inside a 140 liter rotating drum that operates at 25

The mixture of granular ingredients listed above was placed inside a 140 liter rotating drum that operates at 25 rpm. While operating the drum a mixture of nonionic surfactant (C25E3) and a 20% aqueous solution of optical brightener at ratios of 14:1 were sprayed onto the granular mixture to a level of 7% by weight of the granular components. The spraying time was about 1-2 minutes. Immediately afterwards, perfume was sprayed on, at a level of 0.5% by weight of the granular components, while rotating the drum. Then, without stopping the rotation of the drum, a flow aid was slowly added to the mixer, taking about 30 seconds. The type of flow aid used in examples 1 according to the present invention, and reference composition A was partially hydrated zeolite A (6% moisture) and the level of addition was 8%. The type of flow aid used in reference compositions B and C was hydrated zeolite A (16% moisture, supplied by Degussa) and the level of addition was 8%. Once the addition of flow aid was finished, the mixer was allowed to rotate for about 1 minute and was then stopped. The finished product was then removed from the rotating drum.

2 kg of the compositions of references A and B were packed in a closed carton with barried board, with a measured MTVR of 20 g/m²/day.

2 kg of respectively example 1 as well as reference C were packed in a plastic refill bag with a measured MVTR of 5 g/m²/day.

All compositions were stored in a 35° C./80% eRH environment.

The percarbonate recovery was measured as follows:

| Storage conditions | Ref. A | Ref. B | Ref. C | Example 1 |
|---|---|---|---|---|
| 2 weeks 35° C./80% eRH | 73% | 68 | 86% | 94% |
| 3 weeks 35° C./80% eRH | 67% | 58 | 73% | 89% |
| 4 weeks 35° C./80% eRH | 60% | 47 | 72% | 88% |

The eRH measured in the packed product was:
(measured at 35° C.)

| Storage conditions | Ref. A | Ref. B | Ref. C | Example 1 |
|---|---|---|---|---|
| start | 10 | 35 | 35 | 10 |
| 2 weeks 35° C./80% eRH | 42 | 47 | 40 | 18 |
| 4 weeks 35° C./80% eRH | 56 | 51 | 41 | 28 |
| MVTR (g/m2/day | 20 | 20 | 5 | 5 |

The above results show the criticality of using both the selected MVTR and eRH of the present invention.

### Example II

The following laundry detergent composition was prepared:

| Ingredient | Percent by weight |
|---|---|
| Spray-dried powder: | |
| Zeolite | 13% |
| Polymer | 4% |
| Minors | 0.6% |
| Surfactant agglomerate: | |
| Zeolite | 7% |
| Sodium carbonate | 8% |
| LAS (Linear Alkyl Benzene | 7% |
| Sulfonate | |
| C16/18AS (Alkyl Sulfate) | 2.3% |
| CMC | 0.3% |
| Dry-mixed: | |
| Citrate | 1% |
| Layered silicate | 9% |
| Percarbonate* | 18% |
| TAED | 5% |
| Dobanol AE7 | 4% |
| Sodium carbonate | 9% |
| Sodium bicarbonate | 5% |
| Enzyme | 2% |
| Minors | balance to 100 |

The Equilibrium Relative Humidity of the composition as freshly made was 28% at 35° C.
*coated with 2.5% carbonate/sulphate; mean particle size 500 microns.

When stored in a polyethylene laminate refill bag, having a MVTR of 5 g/m²/day, excellent percarbonate stability was measured.

When stored in a propylene bottle with a venting device in its cap, having a MVTR of 2 g/m²/day, excellent percarbonate stability results were also found.

### Example III

An automatic dishwashing detergent composition (percent by weight versus total composition) is prepared according to the following process steps:

Sodium carbonate (5%), sodium silicate (16%), sodium citrate (42%), polymer (4%), TAED (3%), sodium percarbonate particles (10%), enzyme granules (2%) and sodium sulphate (13%) are mixed in a rotating drum.

Nonionic surfactant (1%) is sprayed on in the drum. Dehydrated Zeolite A (10% hydration level) is added as flow aid in the drum.

The resulting composition, having an Equilibrium Relative Humidity of 28% at 35° C. is put in a polyethylene laminate plastic refill bag, having a MVTR of 5 g/m2/day.

Percarbonate stability upon storage is found to be very satisfactory.

### Example IV

The following detergent compositions was prepared:

The following detergent compositions was prepared:
Nonionic Granule

| | |
|---|---|
| 5 | AE3 (Alcohol ethoxylate (3 times |
| | ethoxylated)) |
| 1 | PEG 4000 |
| 7 | Zeolite A (including 0.4% moisture) |
| 7 | Carbonate |
| 20 | |

Spray Dried Granule

| | |
|---|---|
| 5 | TAS (Tallow Alkyl Sulfate) |
| 20 | Zeolite A |
| 7 | Carbonate |
| 5 | Polyacrylate |
| 0.5 | Chelant |
| 0.4 | CMC |
| 0.2 | Brightener |
| 3 | Moisture |

Surfactant Paste

| | |
|---|---|
| 16 | C24AS (Alkyl sulfate) (containing 50% |
| | moisture) |

The nonionic carrier granule, the spray-dried granule and surfactant paste were mixted together in an Eirich RV02 mixter and extruded via a twin screw extruder. The resultant extrudated were cut an spheronised prior to drying in a fluidised bed to a moisture content of 5%. The resulting extrudates were then admixed with the following ingredients:

| | |
|---|---|
| 89.3 | Extrudates |
| 19.0 | Percarbonate |
| 6.3 | TAED |
| 2 | Protease |
| 3 | Antifoam Granules |
| 0.4 | Lipase |
| 100 | |

The finished product had an eRH of 15% at 35° C.

5 Kg fo the product was packed in a refill bag with an MVTR of 9.5 g/m2/day [with surface are of 0.18 m2].

The product was placed on storage at 35° C./80% eRH conditions. A reference of the same product in the same size package with an MVTR of 22 g/.m2/day was tested in parallel (Reference D).

| Storage Conditions | Reference D | Example IV |
|---|---|---|
| 2 weeks 35° C./80% eRH | 71 | 93 |
| 3 weeks 35° C./80% eRH | 58 | 87 |
| 4 weeks 35° C./80% eRH | 53 | 84 |

The eRH measured at 35° C. in the packed product was

| Storage Conditions | Reference D | Example IV |
|---|---|---|
| Start | 15 | 15 |
| 2 weeks 35° C./80% eRH | 38 | 23 |
| 4 weeks 35° C./80% eRH | 57 | 28 |
| MVTR g/m2/day | 22 | 9.5 |

### Example V

The following laundry detergent composition was prepared:

| | % |
|---|---|
| Surfactant Agglommerate | |
| Zeolite MAP | 20 |
| Carbonate | 10 |
| C24AS (Alkyl sulfate) | 15 |
| Moisture | 5 |
| Dry-mixing | |
| Percarbonate | 18* |
| TAED | 5 |
| Sodium Carbonate | 5 |
| Sodium Silicate 2R | 5 |
| Chelant | 0.5 |
| Enzyme | 3 |
| Brightener | 0.2 |
| Antifoam | 3 |
| Spray on | |
| C24E3 Alcohol Ethoxylate | 5 |
| Perfume | 0.3 |
| Coating | |
| Zeolite A (5% moisture) | 5 |

The equilibrium Relative humidity of the product freshly made was 15% at 35° C.
*coated with 3% borosilicate, mean particle size 600 microns.

What is claimed is:

1. A granular detergent combination, said combination comprising:
a) a first component, said component a granular laundry detergent comprising:
i) a percarbonate bleaching agent;
ii) optionally adjunct ingredients;
wherein said first component has a Equilibrium Relative Humidity below 30% at 35° C.; and
b) a second component, said second component a packaging system for containing said first component wherein said packaging system having a Moisture Vapour Transfer Rate of from 1 g/m²/day to less than 20 g/m²/day when said combination is stored at 35° C. and 80% of e RH and said second component is not a wax laminated cardboard carton.

2. The combination according to claim 1 wherein said detergent comprises from 1% to 40% by weight, of percarbonate.

3. The combination according to claim 2 wherein said detergent comprises from 3% to 30% by weight, of percarbonate.

4. The combination according to claim 3 wherein said detergent comprises from 5% to 25% by weight, of percarbonate.

5. The combination according to claim 1 wherein said percarbonate has a mean particle size of from 250 to 900 micrometers.

6. The combination according to claim 5 wherein said percarbonate has a mean particle size of from 500 to 700 micrometers.

7. The combination according to claim 1 wherein said percarbonate is stabilized by admixing a mixed salt therewith, said mixed salt having the formula Na₂SO₄ n Na₂CO₃, wherein n is from 0.3 to 1, ratio of said percarbonate to said mixed salt is from 1:49 to 1:19.

8. The combination according to claim 1 wherein said first component has a bulk density above 650 g/l.

9. The combination according to claim 1 further comprising a detersive surfactant.

10. The combination according to claim 1 wherein said second component has a Moisture Vapour Transfer Rate of from 1 g/m²/day to 15 g/m²/day.

11. The combination according to claim 1 wherein at least one unit of said packaging system consists of a bag or pouch made of monolayer or laminated paper and/or plastic film.

12. The combination according to claim 11 wherein said packaging system consists of such a bag or pouch.

13. The combination according to claim 12 wherein said bag or pouch is a refill bag.

14. The combination according to claim 1 wherein said first component comprises a surfactant is delivered via an agglomerate or an extrudate.

15. The combination according to claim 1 wherein said first component further comprises a builder.

16. A granular detergent combination, said combination comprising:
a) a first component, said component a granular laundry detergent comprising:
i) a percarbonate bleaching agent;
ii) optionally adjunct ingredients;
wherein said first component has a Equilibrium Relative Humidity below 30% at 35° C.; and
b) a second component, said second component a packaging system in the form of a re-fillable bag, said bag having a Moisture Vapour Transfer Rate of from 1 g/m²/day to less than 20 g/m²/day when said combination is stored at 35° C.

17. The combination according to claim 16 wherein said detergent comprises from 5% to 25% by weight, of percarbonate.

18. The combination according to claim 16 wherein said percarbonate has a mean particle size of from 250 to 900 micrometers.

19. The combination according to claim 18 wherein said percarbonate has a mean particle size of from 500 to 700 micrometers.

20. A granular detergent combination, said combination comprising:
a) a first component, said component a granular laundry detergent comprising:
i) 1% to 40% by weight, of a percarbonate bleaching agent;
ii) the balance carriers and adjunct ingredients;
wherein said first component is maintained at a Equilibrium Relative Humidity below 30% at 35° C.; and
b) a second component, said second component a packaging system in the form of a re-fillable bag, said bag having a Moisture Vapour Transfer Rate of from 1 g/m²/day to less than 20 g/m²/day when said combination is stored at 35° C., said bag capable of maintaining said granular laundry detergent at a Equilibrium Relative Humidity below 30% at 35° C.
